(19) United States
(12) Patent Application Publication
(10) Pub. No.: US 2010/0199294 A1
(43) Pub. Date: Aug. 5, 2010

(54) QUESTION AND ANSWER SERVICE METHOD, BROADCAST RECEIVER HAVING QUESTION AND ANSWER SERVICE FUNCTION AND STORAGE MEDIUM HAVING PROGRAM FOR EXECUTING THE METHOD

(75) Inventors: Hyok-sung CHOI, Seoul (KR); Sang-kwon LEE, Suwon-si (KR); Seong-kook SHIN, Suwon-si (KR); Ho-joong KIM, Seongnam-si (KR); Se-jun HAN, Daejeon Metropolitan city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/564,328

(22) Filed: Sep. 22, 2009

(30) Foreign Application Priority Data
Feb. 2, 2009 (KR) 10-2009-0008046

(51) Int. Cl. H04N 7/16

(52) U.S. Cl. 725/13

(57) ABSTRACT

Provided are a question and answer service method for exchanging information related to a program or a scene being viewed, a broadcast receiver having a question and answer service function, and a computer readable storage medium storing a program for executing the method. The question and answer service method includes: obtaining image information on a special area on a screen image displayed on a display unit at a point of time when a question of a user is generated while watching a program; selecting question type information displayed on the display unit with respect to the obtained image information; transmitting information about the obtained image information and information about the selected question type to a server via a network; and outputting, if information about at least one answer to the selected question type information is sent from the server via the network, information on the received answer.

### CROSS-REFERENCE TO RELATED PATENT APPLICATION

This application claims the benefit of Korean Patent Application No. 10-2009-0008046, filed on Feb. 2, 2009, in the Korean Intellectual Property Office, the disclosure of which is incorporated herein in its entirety by reference.

### BACKGROUND OF THE INVENTION

1. Field of the Invention

Methods and apparatuses consistent with the present general inventive concept relates to a question and answer service, and more particularly, to a question and answer service method for exchanging information related to a program or a scene being watched, a broadcast receiver having a question and answer service function and a computer readable storage medium having stored thereon a program for executing the method.

2. Description of the Related Art

With the advent of Internet Protocol television (IPTV), various bi-directional content providing services based on broadcast receivers capable of receiving broadcast signals via various broadcast delivery networks such as a public network, a satellite network, a cable network, and so forth, are suggested. The broadcast receivers may be digital broadcast receivers. The various broadcast delivery networks may be networks for transmitting analog broadcast signals or digital broadcast signals.

In particular, various types of bi-directional content providing services for exchanging information related to a program or a scene being watched are suggested.

### SUMMARY OF THE INVENTION

The present general inventive concept provides a question and answer service method for exchanging information related to a program or a scene being watched, a broadcast receiver having a question and answer service function, and a computer readable storage medium having embodied thereon a program for executing the method.

According to an aspect of the present general inventive concept, there is provided a question and answer service method, the method including: obtaining image information of a special area on a screen image at a point of time when a question of a user is generated while watching a program; selecting question type information with respect to the obtained image information; transmitting information on the obtained image information and the selected question type information to a server via a network; and outputting information with respect to the received answer, when information about at least one answer with respect to the selected question type information is sent from the server via the network.

The question type information may include standardization information based on the obtained image information, and the standardization information may be expressed as one of an image type, a keyword type, and a combination type of an image and a keyword.

The outputting may include: outputting number information of the received answer; and outputting an answer text or an answer list, when an answer is requested to be viewed based on the output number information of the answer, and in the outputting of the answer text or the answer list, if multiple answers exist, an answer text or an answer list arranged according to a policy set in advance may be output.

The outputting of the answer text or the answer list may include: transmitting, when a request for an additional question or for an additional search is generated by using information contained in the output answer text or the output answer list as a keyword, information about the request for an additional question or for an additional search to the server via the network; and outputting, when at least one answer or at least one search result, which is collected in response to the request for an additional question or for an additional search is received, the received answer or the received search result.

The obtained image information may be image information of the whole or a portion of the screen image displayed at a point of time when the question is generated, and the selection of the question type information may be performed according to objects or according to target areas contained in the obtained image information.

The method may further include continuously outputting the currently watched program while obtaining the image information, selecting the question type information, transmitting the selected question type information, and outputting information with respect to an answer.

When the currently watched program is a rebroadcasting program, the information with respect to the received answer may include information about an answer collected when the watched program was originally broadcast.

According to another aspect of the present general inventive concept, there is provided a broadcast receiver including: an information receiving unit which receives question generating information and question type selection information of a user; a network interface unit which connects to a server that provides a question and answer service via a network; a display unit which displays image information; and a control unit which controls the network interface unit and the display unit when the question generating information is received by the information receiving unit while watching a program, in order to perform a question and answer service function based on collective intelligence via bi-directional communication with the server.

When the question generating information is received, the control unit may obtain image information of a special area of a screen image displayed on the display unit, and generate question type information with respect to the obtained image information and display the question type information on the display unit, and when at least one piece of question type selection information is received by the information receiving unit based on the displayed question type information, the control unit may transmit the obtained image information and the question type selection information to the server via the network interface unit, and when information on at least one answer to the question type selection information is sent from the server through the network interface unit, the control unit may perform the question and answer service function that includes displaying information about the answer on the display unit.

The control unit may generate standardization information based on the obtained image information as the question type information. The control unit may generate the standardization information as one of an image type, a keyword type, and a combination type of an image and a keyword.

When number information of an answer to a question is received via the network interface unit, the control unit may display the received number information of the answer on the display unit, and when a request to view an answer is received by the information receiving unit based on the number information of the answer, the controls unit may output an answer text or an answer list which is sent from the server via the network interface unit, to the display unit.

When multiple answers exist, the answer text or the answer list may be arranged according to a policy that is set in advance.

When a request for an additional question or for an additional search by using information contained in the displayed answer text or the displayed answer list as a keyword is generated, the control unit may transmit the request for an additional question or for an additional search to the server via the network interface unit, and display on the display unit at least one piece of information with respect to the request for an additional question or for an additional search sent from the server.

The obtained image information may be image information of the whole or a portion of a screen image displayed at a point of time when the question is generated, and the question type selection information may be defined according to objects or according to target areas contained in the obtained image information.

The control unit may control the currently watched program to be continuously displayed on the display unit when performing the question and answer service function.

When the currently watched program is a rebroadcasting program, the information with respect to the received answer may contain information about answers collected when the watched program was originally broadcast.

According to another aspect of the present general inventive concept, there is provided a computer readable storage medium having embodied thereon a program for executing a question and answer service method, wherein the method is performed as described above.

### BRIEF DESCRIPTION OF THE DRAWINGS

The above and other aspects of the present general inventive concept will become more apparent by describing in detail exemplary embodiments thereof with reference to the attached drawings in which:

FIG. 1 illustrates a configuration of a broadcast receiver and a question and answer service server according to an exemplary embodiment of the present general inventive concept;

FIG. 2 illustrates an example screen for explaining a relationship between image information and question type selection information obtained according to an exemplary embodiment of the present general inventive concept;

FIG. 3 illustrates an example screen on which obtained image information and question type information and standardization information are displayed according to an exemplary embodiment of the present general inventive concept;

FIG. 4 illustrates an example screen on which number information of received answers is displayed according to an exemplary embodiment of the present general inventive concept;

FIG. 5 illustrates an example of questions that are simplified and grouped in a question and answer service server according to an exemplary embodiment of the present general inventive concept; and

FIG. 6 is a flowchart illustrating operations of a question and answer service method according to an exemplary embodiment of the present general inventive concept.

### DETAILED DESCRIPTION OF THE EXEMPLARY EMBODIMENTS

The present general inventive concept will now be described more fully with reference to the accompanying drawings, in which exemplary embodiments of the present general inventive concept are shown.

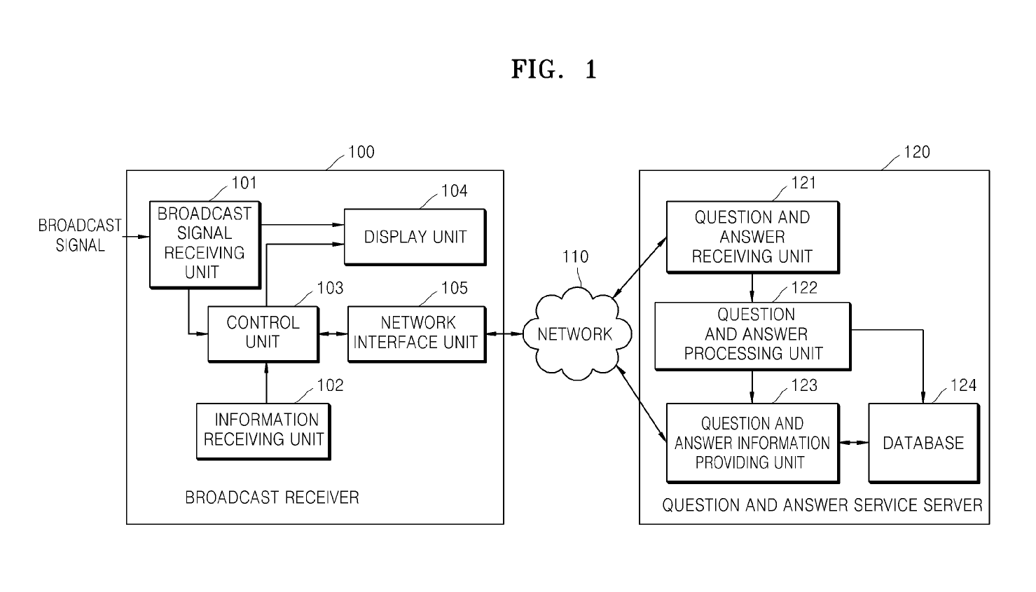

FIG. 1 illustrates a configuration of a broadcast receiver 100 and a question and answer service server 120 according to an exemplary embodiment of the present general inventive concept.

The broadcast receiver 100 illustrated in FIG. 1 is capable of receiving broadcast signals via various broadcast delivery networks such as a public network, a satellite network, a cable network, and so forth. A broadcast delivery network is capable of transmitting a digital broadcast signal or an analog broadcast signal. The broadcast receiver 100 may be a digital broadcast receiver.

Also, the broadcast receiver 100 may provide a question and answer service based on collective intelligence for a program or a scene being watched through a network 110 such as an Internet Protocol (IP) network in bi-directional communication with the question and answer service server 120. The collective intelligence is a shared or group intelligence that emerges from the collaboration and competition of many individuals. The collective intelligence appears in a wide variety of forms of consensus decision making in humans, and computer networks. The study of collective intelligence may properly be considered a subfield of sociology, of business, of computer science, of mass communications and of mass behavior. The broadcast receiver 100 may obtain image information of a specific screen from a received broadcast signal. The obtained image information may be captured screen information. The obtained image information may be image information of the whole or a portion of a displayed screen image. The obtained image information may include at least one piece of object image information or image information of at least one target area. Information on the obtained image information may be detected from electronic program guide (EPG) information included in the received broadcast signal. The broadcast receiver 100 may be a fixed apparatus fixed at a predetermined position or may be a portable apparatus.

The broadcast receiver 100 may include, as illustrated in FIG. 1, a broadcast signal receiving unit 101, an information receiving unit 102, a control unit 103, a display unit 104, and a network interface unit 105.

The broadcast signal receiving unit 101 may receive a digital broadcast signal or an analog broadcast signal transmitted via various broadcast delivery networks such as a public network, a satellite network, or a cable network.

The information receiving unit 102 may receive question generating information and question type selection information of a user. The question generating information of the user is generated as the user controls a remote controller of the broadcast receiver 100 or a question button provided in a front panel of the broadcast receiver 100 and the generated question generating information is received by the information receiving unit 102. The question type selection information is generated when the user controls the remote controller or a button provided in the front panel of the broadcast receiver 100, based on question type information displayed on the display unit 104 and the generated question type selection information is received by the information receiving unit 102.

The information receiving unit 102 may be implemented as a user interface. When the information receiving unit 102 is implemented as a user interface, the question generating information or the question type selection information is generated by a touch on a touch panel included in the user interface or by controlling a remote controller.

Also, the question type selection information received by the information receiving unit 120 may be defined according to objects or target areas included in the obtained image information. If the obtained image information corresponds to one object or to one target area, the question type selection information is question type selection information pertaining to the one object or the one target area. The obtained image information corresponding to one object or to one target area may be obtained image information including one object or one target area.

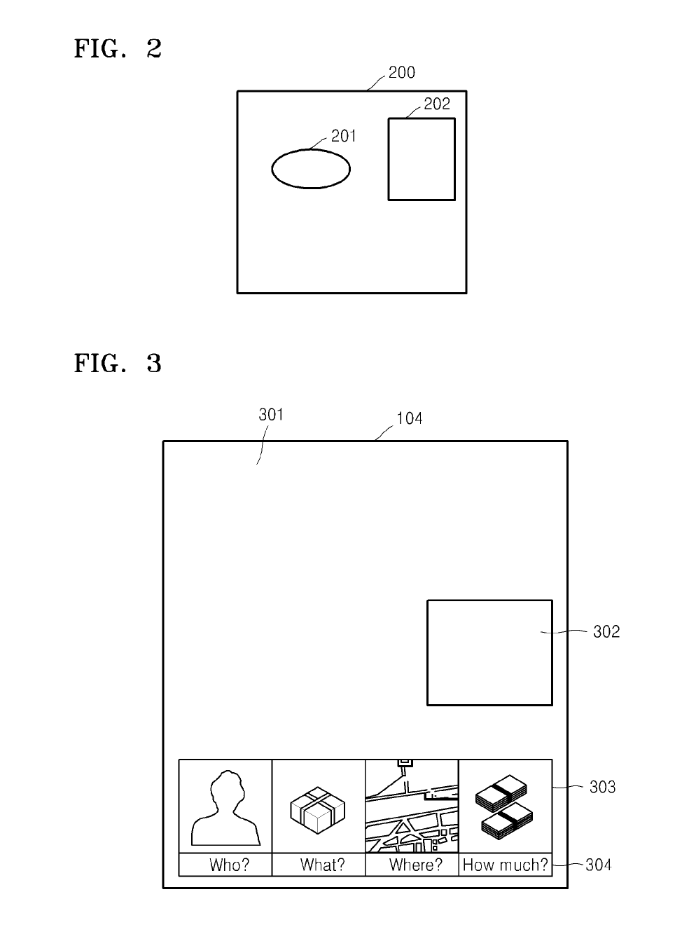

FIG. 2 illustrates an example screen on which the obtained image information including a plurality of objects or a plurality of target areas is displayed. Referring to FIG. 2, a screen 200 is a screen to display the obtained image information, including objects or target areas 201 and 202. Question type information is respectively provided to the object or target area 201 and to the object or target area 202. Based on the respectively provided question type information, the information receiving unit 102 may receive question type selection information according to objects or target areas.

Referring to FIG. 1, when question generating information is received through the information receiving unit 102, the control unit 103 obtains image information of a special area of a screen image displayed on the display unit 104, generates question type information about the obtained image information of the special area, and transmits the generated question type information to the display unit 104 to display the same. The question type information may be generated according to objects or target areas included in the obtained image information of the special area as illustrated in FIG. 2. The obtained image information may be, as described above, the image information of the whole or a portion of the displayed screen image at a point of time when the question generating information is received. Whether the image information is the whole or a portion of the displayed screen image may be determined by the user.

The control unit 103 may generate standardization information based on the obtained image information of the special area as question type information. For example, if the obtained image information contains only information about a person, the control unit 103 may generate standardization information “Who?” as question type information. Also, for example, if the obtained image information contains a person and scenery, the control unit 103 may generate standardization information “Who?” with respect to the person as question type information, and standardization information “Where?” with respect to the scenery as question type information.

Contents contained in the special area of the obtained image information may be detected based on program information contained in the broadcast signal received through the broadcast signal receiving unit 101. That is, after a person and scenery are determined to be contained in image information obtained based on program information included in the broadcast signal received through the broadcast signal receiving unit 101, if selection information regarding the person among the contents contained in the obtained image information is received by the information receiving unit 102, the control unit 103 may generate standardization information with respect to the person, including “Who?”, as question type information.

FIG. 3 illustrates an example screen on which obtained image information of a special area and standardization information based on the obtained image information of the special area are displayed according to an exemplary embodiment of the present general inventive concept. Referring to FIG. 3, a screen image 301 displayed on the display unit 104 is an area on which a broadcast program being currently viewed is displayed. The obtained image information is displayed in an area 302. Question type information 303 and 304 of the obtained image information is displayed in the obtained image information display area 302. In FIG. 3, question type information with respect to the obtained image information 302 such as “Who?”, “What?”, “Where?”, and “How much?” are displayed.

The question type information 303 is an example of standardized image type for question type information, and question type information 304 is an example of standardized keyword type for question type information. As shown in FIG. 3, the question type information of the standardized image type and the standardized keyword type may be displayed at the same time. Alternatively, only standardized image type question type information or only standardized keyword type question type information may be displayed. The standardized image type may be defined using icons.

In FIG. 3, the obtained image information is displayed in a picture-in-picture (PIP) format. However, the obtained image information and the question type information may also be displayed using the whole screen. That is, instead of displaying the currently viewed broadcast program, the obtained image information and the question type information may be displayed.

As such, when a question type is selected based on the displayed question type information, the control unit 103 transmits information about the question type information and the obtained image information to the question and answer service server 120 via the network interface unit 105 and the network 110 (See FIG. 1). The information about the obtained image information may be detected from EPG information contained in the broadcast signal received through the broadcast signal receiving unit 101 as described above. The information about the obtained image information may be, for example, a broadcast date, a broadcast time, a broadcast channel, and a title of a program.

Also, when information regarding at least one answer to the selected question type information is sent from the question and answer service server 120, the control unit 103 transmits the information about the answer to the display unit 104 and displays the same. The information about the at least one answer is collected based on collective intelligence. Therefore, a plurality of answers to the question may exist.

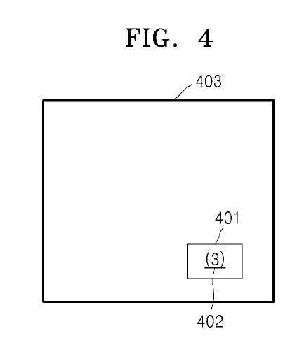

FIG. 4 illustrates an example screen on which number information of received answers is displayed according to an exemplary embodiment of the present general inventive concept. If the received information regarding the answer is number information pertaining to the answer to the question, the control unit 103 may display number information 402 pertaining to the received answer in a number information display area 401 on which the obtained image information is displayed as illustrated in FIG. 4. However, the number information 402 pertaining to the answer may also be displayed as a pop-up in the number information display area 401. Alternatively, the obtained image information may not be displayed and only the number information 402 pertaining to the received answer may be displayed. In FIG. 4, the obtained image information is displayed in a PIP format. However, as described with reference to FIG. 3, the number information pertaining to the received answer may be displayed using a portion of a screen, while displaying the obtained image information using the whole screen.

In FIG. 4, three answers exist to the question. Here, the control unit 103 may control the currently viewed broadcast program to be continuously displayed in an area 403. Accordingly, the user can continue watching the broadcast program while at the same time monitoring a result of a question and answer service for the user.

Referring to FIGS. 1 and 4, when a request to view an answer is received through the information receiving unit 102, the control unit 103 requests an answer text or an answer list from the question and answer service server 120 through the network interface unit 105 and the network 110. When the answer text or the answer list is received from the question and answer service server 120, the control unit 103 may display the answer text or the answer list on the whole screen or on a portion of the screen of the display unit 104. If multiple answers exist, the answer text or the answer list may be arranged based on a policy set in advance in the question and answer service server 120. The answer text or the answer list may be arranged, for example, according to the reputation of an answerer or a number of times the answer is selected by users.

The answer text or the answer list may be received from the question and answer service server 120 together with the number information. In this case, when a request to view an answer is received through the information receiving unit 102, the control unit 103 transmits the answer text or the answer list, which is received and kept along with the number information of the answer, to the display unit 104 and displays the answer text or answer list on the display unit 104. The answer text or the answer list may also be arranged according to a policy set in advance in the question and answer service server 120.

Also, when there is a request for a question or for a search, based on the information contained in the displayed answer text or the displayed answer list as a keyword, the control unit 103 transmits the request for a question or a search to the question and answer service server 120 through the network interface unit 105. Accordingly, if at least one answer regarding a question or at least one search result regarding a search request is received from the question and answer service server 120, the control unit 103 transmits the answer or the search result to the display unit 104 and displays the answer or search result on the display unit 104.

The information that can be used as the keyword may be distinctively displayed among the information contained in the answer text or the answer list, to signify its importance compared to other information. For example, while general information contained in the answer text or the answer list is displayed black, the information used as a keyword may be displayed blue. By selecting the blue information, a request for a question or a search may be generated. For example, the selection may be performed by pressing a corresponding area. If there is additional information in regard to the answer text or the answer list, a question and answer service according to the request for a question or a search using the above-described keyword may be provided. The additional information may be expressed as a file.

Alternatively, information indicating that additional information exists in the answer text or the answer list may be included. In this case, when information about a selection for information indicating that additional information exists is received through the information receiving unit 120, the control unit 103 requests additional information from the question and answer service server 120 via the network interface unit 105. When the additional information is sent from the question and answer service server 120, the control unit 103 may display the additional information on the display unit 104.

The display unit 104 may display the currently viewed program and display standardization information regarding image information obtained in response to a question of the user at the same time, by using a portion of the screen as illustrated in FIG. 3. The currently viewed program may be a live broadcasting program or a rebroadcasting program.

If the program being displayed on the display unit 104 is a rebroadcasting program, answer information pertaining to a question may include both answer information collected when watching an original broadcasting program and answer information collected when watching the rebroadcasting program.

The network interface unit 105 may transmit or receive information in bi-direction manner to/from the network 110, such as in an IP network.

The question and answer service server 120 may be an IPTV service server. When question type information and information about the obtained image information are received from at least one broadcast receiver 100 via the network 110, the question and answer service server 120 may provide a question and answer service based on collective intelligence.

To this end, the question and answer service server 120 simplifies the received question type information. Question simplification may be conducted based on scene conversion or on an object basis or on a basis of target areas. By simplifying questions, various pieces of question type information which are expressed differently but have similar contents are expressed as one piece of question information.

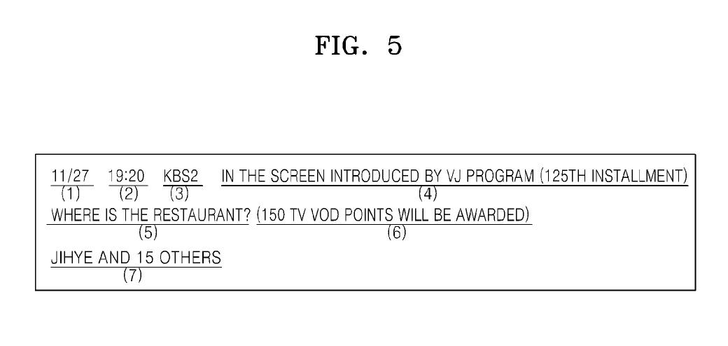

FIG. 5 illustrates an example of how questions are simplified. Question type information that can be simplified as illustrated in FIG. 5 may be, for example: “Where is the place shown in the VJ program (125th installment) broadcast on KBS2 Channel on 11/27 at 19:20?” or “Where is the restaurant shown in the VJ program (125th installment) broadcast on KBS2 Channel on 11/27 at 19:20?”. That is, when the above question type information is sent from the network 110, the question and answer service server 120 simplifies the above question type information to “Where is the restaurant on the screen introduced in the VJ program (125th installment) broadcast on KBS2 Channel on 11/27 at 19:20?”. In the simplified question, “11/27 ((1), broadcast date), 19:20 ((2), broadcast time), KBS2 ((3), broadcast channel), VJ program ((4), program title)” refer to information with respect to the obtained image information, and “Where is the restaurant? ((5)) ” is a question simplified based on the question type information.

After simplifying questions, the question and answer service server 120 may group the simplified questions. That is, when questions of different users are determined as an identical or similar question by question simplification, the question and answer service server 120 groups the questions into one question. Grouping may be performed by comparing previously simplified questions with a currently simplified question. In FIG. 5, questions of a user named Jihye and fifteen other people are determined as similar questions and thus are grouped together. That is, the questions of sixteen users are defined as a single question.

By grouping simplified questions as described above, the users who have asked similar questions may share an answer. That is, in the case of FIG. 5, the question and answer service server 120 may provide an identical answer to the sixteen users who have the similar questions. As described above, by simplifying questions of users which are standardized in the broadcast receiver 100 in the question and answer service server 120 and grouping the simplified questions, similar questions and answers are prevented from being treated differently, thereby efficiently handling questions and answers. That is, the questions and answers can be efficiently handled by defining multiple similar questions as a single question and allowing the users to share an answer thereto.

In addition, in the case of FIG. 5, the question and answer service server 120 provides a reward service whereby 150 TV VOD points are awarded to a user who offers an answer to the question. As described above, the question and answer service server 120 may provide a reward service to a user who offers an answer.

When an answer to the above-described question is received, the question and answer service server 120 notifies the broadcast receiver 100 of the reception via the network 110. At this time, if the received information regarding the answer includes only number information pertaining to the answer to the question, and the user of the broadcast receiver 100 requests to view an answer based on this notification, the question and answer service server 120 transmits an answer text or an answer list related to the provided answer to the broadcast receiver 100. If multiple answers exist, the question and answer service server 120 arranges the answer text or the answer list according to a policy set in advance to transmit the same to the broadcast receiver 100. The policy set in advance may relate to the reputation of the answerer, the number of times the answer is selected by users, and so forth, as described above. When additional information is present, an answer text or an answer list indicating that additional information is present may be transmitted to the broadcast receiver 100 as described above.

When there is a request for an additional question or for a search, based on a keyword indicating that additional information is present, and if additional answers are collected based on the keyword or an additional search is conducted, the question and answer service server 120 may provide the collected answers or a search result to the broadcast receiver 100.

When notifying the presence of the answers received by the broadcast receiver 100, the question and answer service server 120 may transmit a number of the answers and the answer text or the answer list together.

Also, the question and answer service server 120 manages a question and answer list according to users, and may provide the question and answer list whenever desired by a user. A question and answer that is provided once is stored in the question and answer service server 120 and may be used in providing an answer to a question that is generated when viewing a rebroadcasting program.

The question and answer service server 120 may include, as illustrated in FIG. 1, a question and answer receiving unit 121, a question and answer processing unit 122, a question and answer information providing unit 123, and a database 124.

The question and answer receiving unit 121 may respectively receive question type information received via the network 110, information with respect to the obtained image information, and information about an answer. The information about the answer may be in a sentence form, and additional information such as a map, a search result, an advertisement, etc. may be provided. Also, the information about the answer may be in a form to which a user of the broadcast receiver 100 can add an additional question or in a form such that the user can conduct a further search based on the additional information.

The question and answer processing unit 122 simplifies the received question type information as described above, and groups the simplified questions as described above. When an answer to the simplified question is received, the question and answer processing unit 122 notifies the question and answer information providing unit 123 about the reception of the answer. The question and answer information providing unit 123 provides answer information pertaining to the question to the broadcast receiver 100 via the network 110.

The question and answer processing unit 122 makes a question list of questions from users and stores the same in the database 124. Also, the question and answer processing unit 122 stores previously handled questions and answers in the database 124. Accordingly, if a question received by the question and answer receiving unit 121 is a question generated when watching a rebroadcasting program, the database 124 is searched to immediately provide an answer to the question to the broadcast receiver 100 through the question and answer information providing unit 123. Also, when a new answer to the question generated when watching a rebroadcasting program is received by the question and answer receiving unit 121, the question and answer processing unit 122 controls the question and answer information providing unit 123 such that the new answer is also provided as an answer to the question, and updates the information stored in the database 124.

As described above, when watching a live program or a rebroadcasting program, the broadcast receiver 100 may provide answers to a question based on collective intelligence.

Also, the question and answer processing unit 122 may control a reward service and grouped information described with reference to FIG. 5. Also, the question and answer processing unit 122 may be used to provide information in response to a request for an additional question or a search. When the additional question is asked or a further search is conducted, the provided information may contain an advertisement.

The database 124 may be an information storage unit, for example but not limited to, one or more hard disk drives, or memory devices. The database 124 may store question list information according to users and question and answer contents information according to users and control the same. However, since the information stored in the database 124 is based on information collected according to generated questions, the information stored in the database 124 does not have to be managed to provide an answer based on forecasted questions. Thus, costs of managing a database can be reduced.

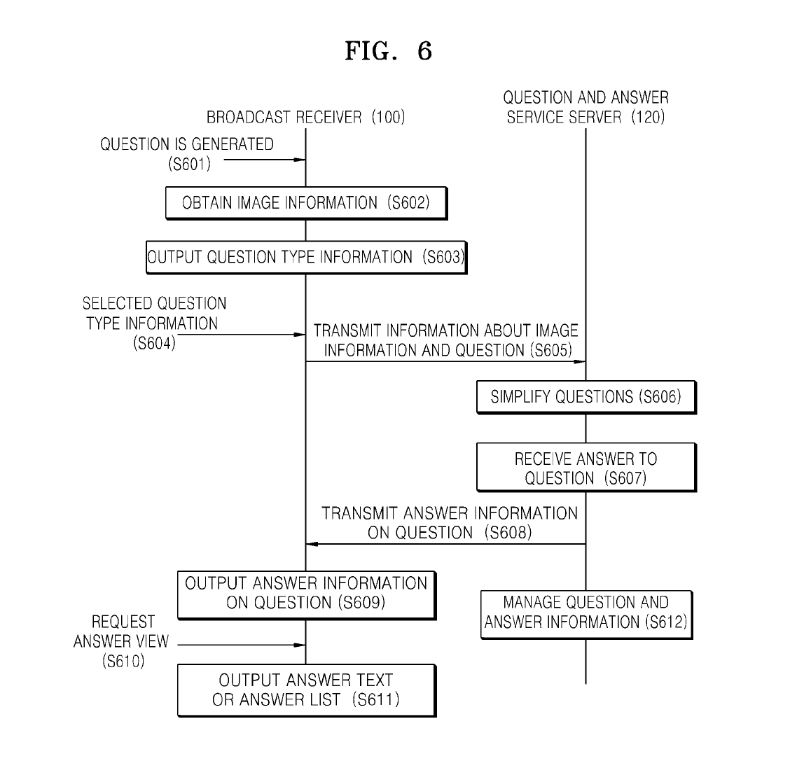

FIG. 6 is a flowchart illustrating operations of a question and answer service method according to an exemplary embodiment of the present general inventive concept.

Referring to FIG. 6, when a question of a user is generated when watching a program (S601), a broadcast receiver 100 obtains image information of a special area on a screen at a point of time when the question is generated (S602). The obtained image information may be in the form of a captured screen. The obtained image information may be displayed using a portion of the screen image as described above with reference to FIG. 3. The broadcast receiver 100 continuously outputs the program being currently viewed so that it can be continuously watched by the user. However, the obtained image information may also be displayed using the whole screen image.

The broadcast receiver 100 analyzes contents of the obtained image information and outputs question type information of the obtained image information based on the analyzed contents (S603). The question type information is standardization information based on contents. The standardization information may be determined according to contents as described above with reference to FIG. 3. Also, as described above with reference to FIG. 2, the standardization information may be defined according to contents of objects or contents of target areas included in the obtained image information.

When question type information selected by the user is received based on the output question type information (S604), the broadcast receiver 100 transmits information about the obtained image information and the selected question type information to the question and answer service server 120 (S605). The information about the obtained image information is the same as the obtained image information described with reference to FIG. 1.

The question and answer service server 120 simplifies the received question type information (S606) as described above with reference to FIG. 5. Accordingly, similar question type information may be defined as identical question type information. The question and answer service server 120 may group simplified questions in a manner as described above with reference to FIG. 5. By grouping, multiple questions are classed as a single question, and the single question may be shared by users who have asked the multiple questions which are similar to each other.

When an answer to the question is received (S607), the question and answer service server 120 transmits answer information pertaining to the question to the broadcast receiver 100 (S608). The answer may be provided in various formats as described above with reference to FIG. 1.

The broadcast receiver 100 outputs answer information to the question (S609). This answer information may be number information of the answer. When an answer view is requested by the user (S610) based on the output answer information, the broadcast receiver 100 outputs an answer text or an answer list (S611). If multiple answers exist, the answer text or the answer list may be aligned according to a policy set in advance in the question and answer service server 120.

However, if the answer information provided in operation S608 include only the number information of the provided answer to the question, the answer information output in operation S609 is the number information of the answer. When requests to view an answer in operation S610 based on the number information, the broadcast receiver 100 requests the question and answer service server 120 for an answer text or an answer list, the question and answer service server 120 provides the answer text or the answer list to the broadcast receiver 100, and the broadcast receiver 100 may output the answer text or the answer list.

Also, when there is a request for an additional question or for a further search using the information included in the output answer text or the output answer list as a keyword, the broadcast receiver 100 transmits the request for an additional question or for a further search to the question and answer service server 120. Accordingly, the question and answer service server 120 collects at least one answer or at least one search result related to the request and transmits the collected answer or the collected search result to the broadcast receiver 100. Accordingly, the broadcast receiver 100 may output the received answer or the received search result.

The question and answer service server 120 manages question and answer information (S612) as described above with reference to FIG. 1. Accordingly, when providing an answer to the question generated during a rebroadcasting program, the question and answer information collected when the program was originally broadcast may be used. Also, a question list or question and answer contents related to questions asked by users may be provided whenever desired by a user.

According to the exemplary embodiment of the present general inventive concept, even when the user is watching live contents, an answer to a question of the user can be provided, and there is no need to compose a database in advance for the purpose of providing answers to questions generated by the user, and thus the costs of managing a database can be saved. Also, by simplifying questions of the user based on standardization information and grouping multiple questions that are similar to one another into a single question, formation of various answers for similar questions is prevented. Thus, the question and answer information can be efficiently handled and a question and answer service based on collective intelligence can be provided.

Also, when inputting an answer, connectable additional information such as a map, a search result, an advertisement, and so forth may be provided, and an additional question may be asked or an additional search may be conducted based on the additional information.

A program for executing the question and answer service method according to the present general inventive concept can also be embodied as computer readable codes on a computer readable recording medium. When executed, the computer readable codes cause a computer to execute the question and answer service method according to the present general inventive concept. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the appended claims. The exemplary embodiments should be considered in a descriptive sense only and not for purposes of limitation. Therefore, the scope of the present general inventive concept is defined not by the detailed description of the invention but by the appended claims, and all differences within the scope will be construed as being included in the present general inventive concept.

What is claimed is:

1. A question and answer service method comprising:
obtaining image information of a special area of a screen image displayed on a display unit at a point of time when a question of a user is generated while watching a program;
selecting question type information displayed on the display unit with respect to the obtained image information;
transmitting information on the obtained image information and the selected question type information to a server via a network; and
outputting information with respect to the received answer, if information about at least one answer with respect to the selected question type information is sent from the server via the network.

2. The method of claim 1, wherein the question type information comprises standardization information based on the obtained image information.

3. The method of claim 2, wherein the standardization information is displayed as one of an image type, a keyword type, and a combination type of an image and a keyword.

4. The method of claim 1, wherein the outputting comprises:
outputting number information of the received answer; and
outputting an answer text or an answer list, if an answer is requested to be viewed based on the output number information of the answer.

5. The method of claim 4, wherein the outputting of the answer text or the answer list comprises, if multiple answers exist, outputting an answer text or an answer list arranged according to a policy set in advance.

6. The method of claim 4, wherein the outputting of the answer text or the answer list comprises:
transmitting, if a request for an additional question or for an additional search is generated by using information contained in the output answer text or the output answer list as a keyword, information about the request for an additional question or for an additional search to the server via the network; and
outputting, if at least one answer or at least one search result, which is collected in response to the request for an additional question or for an additional search is received, the received answer or the received search result.

7. The method of claim 1, wherein the obtained image information is image information of at least a portion of the screen image displayed at a point of time when the question is generated, and the selection of the question type information is performed according to objects or according to target areas contained in the obtained image information.

8. The method of claim 1, further comprising continuously outputting the currently watched program while obtaining the image information, selecting the question type information, transmitting the selected question type information, and outputting information with respect to an answer.

9. The method of claim 1, wherein when the currently watched program is a rebroadcasting program, the information with respect to the received answer comprises information about an answer collected when the watched program was originally broadcast.

10. A broadcast receiver comprising:
an information receiving unit which receives question generating information and question type selection information of a user;
a network interface unit which connects to a server that provides a question and answer service via a network;
a display unit which displays image information; and
a control unit which controls the network interface unit and the display unit if the question generating information is received by the information receiving unit while watching a program, in order to perform a question and answer service function based on collective intelligence via bi-directional communication with the server.

11. The broadcast receiver of claim 10, if when the question generating information is received, the control unit obtains image information of an area of a screen image displayed on the display unit, and generates question type information with respect to the obtained image information and displays the question type information on the display unit, and
if at least one piece of question type selection information is received by the information receiving unit based on the displayed question type information, the control unit transmits the obtained image information and the question type selection information to the server via the network interface unit, and
if information on at least one answer to the question type selection information is sent from the server through the network interface unit, the control unit performs the question and answer service function that comprises displaying information about the answer on the display unit.

12. The broadcast receiver of claim 11, wherein the control unit generates standardization information based on the obtained image information as the question type information.

13. The broadcast receiver of claim 12, wherein the control unit generates the standardization information as one of an image type, a keyword type, and a combination type of an image and a keyword.

14. The broadcast receiver of claim 11, wherein if number information of an answer to a question is received via the network interface unit, the control unit displays the received number information of the answer on the display unit, and if a request to view an answer is received by the information receiving unit based on the number information of the answer, the control unit outputs an answer text or an answer list which is sent from the server via the network interface unit, to the display unit.

15. The broadcast receiver of claim 14, wherein if multiple answers exist, the answer text or the answer list is arranged according to a policy that is set in advance.

16. The broadcast receiver of claim 14, wherein when a request for an additional question or for an additional search by using information contained in the displayed answer text or the displayed answer list as a keyword is generated, the control unit transmits the request for an additional question or for an additional search to the server via the network interface unit, and displays on the display unit at least one piece of information with respect to the request for an additional question or for an additional search sent from the server.

17. The broadcast receiver of claim 11, wherein the obtained image information is image information of at least a portion of a screen image displayed at a point of time when the question is generated, and the question type selection information is defined according to objects or according to target areas contained in the obtained image information.

18. The broadcast receiver of claim 11, wherein the control unit controls the currently watched program to be continuously displayed on the display unit when performing the question and answer service function.

19. The broadcast receiver of claim 11, wherein when the currently watched program is a rebroadcasting program, the information with respect to the received answer contains information about answers collected when the watched program was originally broadcast.

20. A computer readable storage medium having embodied thereon a program for causing a computer to execute a question and answer service method, the program including computer executable codes for performing steps comprising:
obtaining image information of a special area of a screen image displayed on a display unit at a point of time when a question of a user is generated while watching a program;
selecting a question type with respect to the obtained image information displayed on the display unit;
transmitting information about the obtained image information and information about the selected question type to a server via a network; and
outputting information on the received answer, if information about at least one answer to the selected question type information is sent from the server via the network.
